(19) United States
(12) Patent Application Publication
(10) Pub. No.: US 2026/0113654 A1
(43) Pub. Date: Apr. 23, 2026

(54) CHANNEL STATE INFORMATION PROCESSING UNIT FOR ARTIFICIAL INTELLIGENCE BASED REPORT GENERATION

(71) Applicant: Telefonaktiebolaget LM Ericsson (publ), Stockholm (SE)

(72) Inventors: Xinlin ZHANG, Västra Frölunda (SE); Yufei BLANKENSHIP, Kildeer, IL (US); Mattias FRENNE, Uppsal (SE); Jingya LI, Göteborg (SE); Siva MURUGANATHAN, Stittsville (CA)

(21) Appl. No.: 19/115,029

(22) PCT Filed: Sep. 29, 2023
(86) PCT No.: PCT/SE2023/050969

§ 371 Date: Mar. 25, 2025

Related U.S. Application Data
(60) Provisional application No. 63/412,135, filed on Sep. 30, 2022.

(51) Int. Cl. H04W 24/10

(52) U.S. Cl. CPC H04W 24/10

(57) ABSTRACT

A method, system and apparatus are disclosed. A wireless device (WD) configured to communicate with a network node is described. The WD is configured to determine a first channel state information (CSI) processing unit (CPU) of a first CPU type based on a first characteristic of a first CSI report, where the first CPU type is an artificial intelligence CPU type, and generate the first CSI report using the first CPU and an artificial intelligence process, where the first CSI report has a first CPU occupancy. One or more actions are performed based on the first CSI report.

### TECHNICAL FIELD

The present disclosure relates to wireless communications, and in particular, to report processing units associated with reporting based on artificial intelligence and/or machine learning.

### BACKGROUND

The Third Generation Partnership Project (3GPP) has developed and is developing standards for Fourth Generation (4G) (also referred to as Long Term Evolution (LTE)), Fifth Generation (5G) (also referred to as New Radio (NR)), and Sixth Generation (6G) wireless communication systems. Such systems provide, among other features, broadband communication between network nodes (NNs), such as base stations, and mobile wireless devices (WD) such as user equipment (UE), as well as communication between network nodes and between WDs.

### Channel State Information (CSI) Reporting in NR

In NR, a WD can be configured with one or multiple CSI Report Settings, each configured by a higher layer parameter CSI-ReportConfig. Each CSI-ReportConfig may be associated with a bandwidth part (BWP) and include one or more of the following:
a CSI resource configuration for channel measurement:
a CSI interference measurement (CSI-IM) resource configuration for interference measurement:
reporting configuration type, i.e., aperiodic CSI (on physical uplink shared channel (PUSCH)), periodic CSI (on physical uplink control channel (PUCCH)), or semi-persistent CSI on PUCCH or PUSCH:
report quantity specifying what to be reported, such as rank indicator (RI), precoding matrix indicator (PMI), channel quality indicator (CQI):
codebook configuration such as type I or type II CSI:
frequency domain configuration, i.e., subband vs. wideband CQI or PMI, and subband size:
CQI table to be used.

A WD can be configured with one or multiple CSI resource configurations for channel measurement and one or more CSI-IM resources for interference measurement. Each CSI resource configuration for channel measurement can contain one or more nonzero power CSI reference signal (NZP CSI-RS) resource sets. For each NZP CSI-RS resource set, it can further contain one or more NZP CSI-RS resources. A NZP CSI-RS resource can be periodic, semi-persistent, or aperiodic.

Similarly, each CSI-IM resource configuration for interference measurement can contain one or more CSI-IM resource sets. For each CSI-IM resource set, it can further contain one or more CSI-IM resources. A CSI-IM resource can be periodic, semi-persistent, or aperiodic.

### CSI Reporting Types and CSI-RS Configuration Types

A summary is provided in Table 1 below for the CSI reporting types and CSI-RS configuration types supported in NR.

TABLE 1
The CSI reporting types, and CSI-RS configuration types supported in NR.

| CSI-RS | Periodic CSI | Semi-Persistent | Aperiodic CSI |
|---|---|---|---|
| Configuration | Reporting | CSI Reporting | Reporting |
| Periodic CSI-RS | No dynamic | For reporting on | Triggered by DCI; |
| | triggering/activation | PUCCH, the WD | additionally, |
| | | receives an | subselection |
| | | activation | indication is |
| | | command; | supported. |
| | | For reporting on | |
| | | PUSCH, the WD | |
| | | receives triggering | |
| | | on DCI | |
| Semi-Persistent | Not Supported | For reporting on | Triggered by DCI; |
| CSI-RS | | PUCCH, the WD | additionally, |
| | | receives an | subselection |
| | | activation | indication is |
| | | command; | supported. |
| | | For reporting on | |
| | | PUSCH, the WD | |
| | | receives triggering | |
| | | on DCI | |
| Aperiodic CSI-RS | Not Supported | Not Supported | Triggered by DCI; |
| | | | additionally, |
| | | | subselection |
| | | | indication is |
| | | | supported. |
| Physical channel to | Periodic CSI report is | Semi-Persistent | Aperiodic CSI |
| carry the CSI report | carried on PUCCH | CSI report is | report is carried on |
| | | carried on PUSCH | PUSCH |
| | | or PUCCH | |

### CSI Processing Unit (CPU) for Computing CSI Report

In NR, the concept of CPU was introduced, where the number of CPUs, denoted as N_{CPU}, is equal to the number of simultaneous CSI calculations supported by the WD. The WD indicates N_{CPU} to the network node as part of the WD capability. When the WD is triggered for a CSI report, a certain number of CPUs, denoted as O_{CPU}, may be allocated to the WD from the available CPU pool, which will be occupied for a period of time (measured in symbols). If there are not enough CPUs for a given time instance, the newly triggered CSI report does not need to be calculated by the WD.

The number of occupied CPUs for a given CSI report depends on the content (configured by higher layer parameter ‘reportQuantity’), actually the complexity, for calculating it. The followings options are based on the current 3GPP NR specification technical specification (TS) 38.214 v17.2.0:
When ‘reportQuantity’ is set to ‘none’ and aperiodic TRS is configured, then the TRS is mainly used for time and/or frequency synchronization at the WD, and nothing needs to be reported. In addition, the WD is assumed to have dedicated resources for TRS processing. Therefore, for this case, O_{CPU}=0.
When ‘reportQuantity’ is set to beam related parameters, such as ‘cri-RSRP’, ‘ssb-Index-RSRP’, etc., O_{CPU}=1, since beam related processing is usually not complex.
When ‘reportQuantity’ is set to non-beam related parameters, such as ‘cri-RI-PMI-CQI’, ‘cri-RI-i1’, etc., the CSI report occupies as many CPUs as the number of CSI-RS resources in the CSI-RS resource set for channel measurement.

The period of time (measured by the number of symbols) for which the CPU is occupied for a given CSI report depends on the time domain behavior of the CSI report, e.g.:
For periodic or semi-persistent CSI report, the CPU is occupied from the first symbol of the earliest CSI-RS/CSI-IM/SSB resource for channel or interference measurement, no later than the CSI-RS reference resource, until the last symbol of the configured PUSCH/PUCCH carrying the report. For the example in FIG. 1, one CSI-RS resource is configured to the WD for channel measurement (denoted by the first bar), then T′ is the CPU occupancy period for periodic or semi-persistent CSI report.
For aperiodic CSI report, the CPU is occupied from the first symbol after the PDCCH triggering the CSI report, until the last symbol of the scheduled PUSCH carrying the report. For the example, in FIG. 1, T″ is the CPU occupancy period for periodic or semi-persistent CSI report.

### AI ML for Physical Layer

Artificial Intelligence (AI)/Machine Learning (ML) have been investigated as promising tools to optimize the design of air-interface in wireless communication networks in both academia and industry. Example use cases include using autoencoders for CSI compression to reduce the feedback overhead and improve channel prediction accuracy; using deep neural networks for classifying line of sight (LOS) and non-LOS (NLOS) conditions to enhance the positioning accuracy; and using reinforcement learning for beam selection at the network side and/or the WD side to reduce the signaling overhead and beam alignment latency; using deep reinforcement learning to learn an optimal precoding policy for complex multiple input multiple output (MIMO) precoding problems.

When applying AI/ML on air-interference use cases, different levels of collaboration between network nodes and WDs can be considered:
No collaboration between network nodes and WDs. In this case, a proprietary AI/ML model operating with the existing standard air-interface is applied at one end of the communication chain (e.g., at the WD side). The model life cycle management (e.g., model selection/training, model monitoring, model retraining, model update) may be performed at the node without inter-node assistance (e.g., assistance information provided by the network node).
Limited collaboration between network nodes and WDs. In this case, an AI/ML model is operating at one end of the communication chain (e.g., at the WD side), but this node gets assistance from the node(s) at the other end of the communication chain (e.g., a gNB) for its AI/ML model life cycle management (e.g., for training/retraining the AI/ML model, model update).
Joint AI/ML operation between network notes and WDs. In this case, the AI/ML model is assumed to be split with one part located at the network side and the other part located at the WD side. Hence, the AI/ML model may require joint training between the network and WD, and the AI/ML model life cycle management may involve both ends of a communication chain.

In 3GPP NR technical specification (TS) 38.214 v17.2.0, the concept of CSI processing unit (CPU) is defined only for legacy CSI report. Further, a CSI processing capability is not defined, e.g., when both legacy CPU and AI/ML based CPU are used for calculating a CSI report.

### SUMMARY

Some embodiments advantageously provide methods, systems, and apparatuses for determining report processing unit(s) associated with reporting based on artificial intelligence and/or machine learning. In some embodiments, CSI processing capability (e.g., processing capacity, occupancy) is described. The CSI processing capability may be determined for reporting when legacy and AI/ML based CPUs are used, e.g., for calculating a CSI report. In some other embodiments, an AI/ML model is trained and/or validated for deployment.

In one or more embodiments, a type of CSI processing unit (CPU) is described for AI/ML-based CSI reporting. In an embodiment, one or more methods for handling CPU occupancy are described, e.g., when both legacy CPU and AI CPU are used for calculating a CSI report.

In some embodiments, the type of CSI processing unit (CPU) may comprise an AI-CPU type. In some other embodiments, one or more methods for indicating the maximum number of AI-CPUs that can be supported by a WD are described. In an embodiment, a number of AI-CPUs for a given report quantity (e.g., reportQuantity) is determined. In another embodiments, the AI-CPU occupancy period in time is determined. In some embodiments, a process for handling AI-CPU and legacy CPU when both the AI-CPU and the legacy CPU are used for deriving a CSI report is described.

One or more embodiments provide ways to quantify, measure and/or monitor CSI processing timeline, which may help a network node such as a gNB efficiently configure CSI report(s).

According to an aspect, a wireless device (WD) configured to communicate with a network node is described. The WD is configured to determine a first channel state information (CSI) processing unit (CPU) of a first CPU type based on a first characteristic of a first CSI report, where the first CPU type is an artificial intelligence CPU type, and generate the first CSI report using the first CPU and an artificial intelligence process, where the first CSI report has a first CPU occupancy. One or more actions are performed based on the first CSI report.

In some embodiments, the WD is further configured to at least one of: (A) determine a second CPU of a second CPU type based on a second characteristic of a second CSI report, where the second CPU type and the first CPU type are different; (B) generate the second CSI report using the second CPU, where the second CSI report has a second CPU occupancy; and (C) perform the one or more actions further based on the second CSI report.

In some embodiments, performing the one or more actions includes transmitting at least one of the first CSI report and the second CSI report to the network node.

In some embodiments, at least one of: (A) the first CPU occupancy includes a first CPU occupancy period; (B) the first CPU occupancy period starts after a time offset relative to a trigger signal transmitted by the network node; and (C) the second CPU occupancy includes a second CPU occupancy period.

In some other embodiments, the first CPU occupancy period overlaps at least in part with the second CPU occupancy period.

In some embodiments, the WD is further configured to determine a total CPU occupancy period based on the first CPU occupancy period and the second CPU occupancy period.

In some other embodiments, the first CPU occupancy includes a quantity of CPUs of the first CPU type that the first CSI report occupies to generate the first CSI report.

In some embodiments, the WD is further configured to determine a third CPU of the first CPU type based on at least in part on the quantity of CPUs of the first CPU type that the first CSI report occupies. The first CSI report is generated further using the third CPU.

In some other embodiments, the WD is further configured to at least one of: (A) determine a first indication indicating a WD capability of supporting the first CPU type; (B) determine a second indication indicating a maximum quantity of CPUs of the first CPU type supported by the WD; (C) determine a third indication indicating a maximum quantity of CSI calculations supported by the WD; and (D) transmit at least one of the first indication, the second indication, and the third indication to the network node.

In some embodiments, the WD is further configured to, in response to at least one of the first indication, the second indication, and the third indication, receive, from the network node, signaling usable by the WD to generate at least the first CSI report using the first CPU.

According to another aspect, a method in a wireless device (WD) configured to communicate with a network node is described. The method includes determining a first channel state information (CSI) processing unit (CPU) of a first CPU type based on a first characteristic of a first CSI report. The first CPU type is an artificial intelligence CPU type. The method further includes generating the first CSI report using the first CPU and an artificial intelligence process, where the first CSI report has a first CPU occupancy, and performing one or more actions based on the first CSI report.

In some embodiments, the method further includes at least one of: (A) determining a second CPU of a second CPU type based on a second characteristic of a second CSI report, where the second CPU type and the first CPU type are different; (B) generating the second CSI report using the second CPU, where the second CSI report has a second CPU occupancy; and (C) performing the one or more actions further based on the second CSI report.

In some other embodiments, performing the one or more actions includes transmitting at least one of the first CSI report and the second CSI report to the network node.

In some embodiments, at least one of: (A) the first CPU occupancy includes a first CPU occupancy period; (B) the first CPU occupancy period starts after a time offset relative to a trigger signal transmitted by the network node; and (C) the second CPU occupancy includes a second CPU occupancy period.

In some other embodiments, the first CPU occupancy period overlaps at least in part with the second CPU occupancy period.

In some embodiments, the method further includes determining a total CPU occupancy period based on the first CPU occupancy period and the second CPU occupancy period.

In some other embodiments, the first CPU occupancy includes a quantity of CPUs of the first CPU type that the first CSI report occupies to generate the first CSI report.

In some embodiments, the method further includes determining a third CPU of the first CPU type based on at least in part on the quantity of CPUs of the first CPU type that the first CSI report occupies, the first CSI report being generated further using the third CPU.

In some other embodiments, the method further includes at least one of: (A) determining a first indication indicating a WD capability of supporting the first CPU type; (B) determining a second indication indicating a maximum quantity of CPUs of the first CPU type supported by the WD; (C) determining a third indication indicating a maximum quantity of CSI calculations supported by the WD; and (D) transmitting at least one of the first indication, the second indication, and the third indication to the network node.

In some other embodiments, the method further includes, in response to at least one of the first indication, the second indication, and the third indication, receiving, from the network node, signaling usable by the WD to generate at least the first CSI report using the first CPU.

According to an aspect, a network node configured to communicate with a wireless device (WD) is described. The network node is configured to transmit, to the WD, signaling usable by the WD to generate at least a first channel state information (CSI) report using a first CSI processing unit (CPU) of a first CPU type and an artificial intelligence process. The first CSI report has a first CPU occupancy, and the first CPU type is an artificial intelligence CPU type. The network node is further configured to receive the first CSI report.

In some embodiments, the signaling is usable by the WD to further generate a second CSI report using a second CPU of a second CPU type. The second CSI report has a second CPU occupancy. The second CPU type and the first CPU type are different.

In some other embodiments, the network node is further configured to receive the second CSI report from the WD.

In some embodiments, at least one of: (A) the first CPU occupancy includes a first CPU occupancy period; (B) the first CPU occupancy period starts after a time offset relative to a trigger signal transmitted by the network node; and (C) the second CPU occupancy includes a second CPU occupancy period.

In some other embodiments, the first CPU occupancy period overlaps at least in part with the second CPU occupancy period.

In some embodiments, a total CPU occupancy period is based on the first CPU occupancy period and the second CPU occupancy period.

In some other embodiments, the first CPU occupancy includes a quantity of CPUs of the first CPU type that the first CSI report occupies to generate the first CSI report.

In some embodiments, the signaling is usable by the WD to further generate the first CSI report using a third CPU of the first CPU type based on at least in part on the quantity of CPUs of the first CPU type that the first CSI report occupies.

In some other embodiments, the network node is further configured to at least one of: (A) receive a first indication indicating a WD capability of supporting the first CPU type; (B) receive a second indication indicating a maximum quantity of CPUs of the first CPU type supported by the WD; and (C) receive a third indication indicating a maximum quantity of CSI calculations supported by the WD.

In some embodiments, the maximum quantity of CSI calculations includes at least one of: (A) a quantity of simultaneous CSI reports per component carrier to be generated using the artificial intelligence process; and (B) another quantity of simultaneous CSI reports for a plurality component carriers to be generated using the artificial intelligence process.

According to another aspect, a method in a network node configured to communicate with a wireless device (WD) is described. The method includes transmitting, to the WD, signaling usable by the WD to generate at least a first channel state information (CSI) report using a first CSI processing unit (CPU) of a first CPU type and an artificial intelligence process. The first CSI report has a first CPU occupancy, and the first CPU type is an artificial intelligence CPU type. The method further includes receiving the first CSI report.

In some embodiments, the signaling is usable by the WD to further generate a second CSI report using a second CPU of a second CPU type. The second CSI report has a second CPU occupancy, and the second CPU type and the first CPU type are different.

In some other embodiments, the method further includes receiving the second CSI report from the WD.

In some embodiments, at least one of: (A) the first CPU occupancy includes a first CPU occupancy period; (B) the first CPU occupancy period starts after a time offset relative to a trigger signal transmitted by the network node; and (C) the second CPU occupancy includes a second CPU occupancy period.

In some other embodiments, the first CPU occupancy period overlaps at least in part with the second CPU occupancy period.

In some embodiments, a total CPU occupancy period is based on the first CPU occupancy period and the second CPU occupancy period.

In some other embodiments, the first CPU occupancy includes a quantity of CPUs of the first CPU type that the first CSI report occupies to generate the first CSI report.

In some embodiments, the signaling is usable by the WD to further generate the first CSI report using a third CPU of the first CPU type based on at least in part on the quantity of CPUs of the first CPU type that the first CSI report occupies.

In some other embodiments, the method further includes at least one of: (A) receiving a first indication indicating a WD capability of supporting the first CPU type:

(B) receiving a second indication indicating a maximum quantity of CPUs of the first CPU type supported by the WD; and (C) receiving a third indication indicating a maximum quantity of CSI calculations supported by the WD.

In some embodiments, the maximum quantity of CSI calculations includes at least one of: (A) a quantity of simultaneous CSI reports per component carrier to be generated using the artificial intelligence process; and (B) another quantity of simultaneous CSI reports for a plurality component carriers to be generated using the artificial intelligence process.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 shows an example CPU occupancy period;

FIG. 2 is a schematic diagram of an example network architecture illustrating a communication system connected via an intermediate network to a host computer according to the principles in the present disclosure:

FIG. 3 is a block diagram of a host computer communicating via a network node with a wireless device over an at least partially wireless connection according to some embodiments of the present disclosure:

FIG. 4 is a flowchart illustrating example methods implemented in a communication system including a host computer, a network node and a wireless device for executing a client application at a wireless device according to some embodiments of the present disclosure:

FIG. 5 is a flowchart illustrating example methods implemented in a communication system including a host computer, a network node and a wireless device for receiving user data at a wireless device according to some embodiments of the present disclosure:

FIG. 6 is a flowchart illustrating example methods implemented in a communication system including a host computer, a network node and a wireless device for receiving user data from the wireless device at a host computer according to some embodiments of the present disclosure;

FIG. 7 is a flowchart illustrating example methods implemented in a communication system including a host computer, a network node and a wireless device for receiving user data at a host computer according to some embodiments of the present disclosure:

FIG. 8 is a flowchart of an example process in a network node according to some embodiments of the present disclosure:

FIG. 9 is a flowchart of an example process in a wireless device according to some embodiments of the present disclosure:

FIG. 10 is a flowchart of another example process in a wireless device according to some embodiments of the present disclosure:

FIG. 11 is a flowchart of another example process in a network node according to some embodiments of the present disclosure:

FIG. 12 is a flowchart of an example CPU occupancy when both legacy and AI-CPU are used for calculating a CSI report according to some embodiments of the present disclosure:

FIG. 13 is a flowchart of an example CPU occupancy when both legacy and AI-CPU are used for calculating a CSI report with overlapping between legacy CPU and AI-CPU according to some embodiments of the present disclosure; and

FIG. 14 shows an example independent occupancy; legacy CPU and AI-CPU according to some embodiments of the present disclosure.

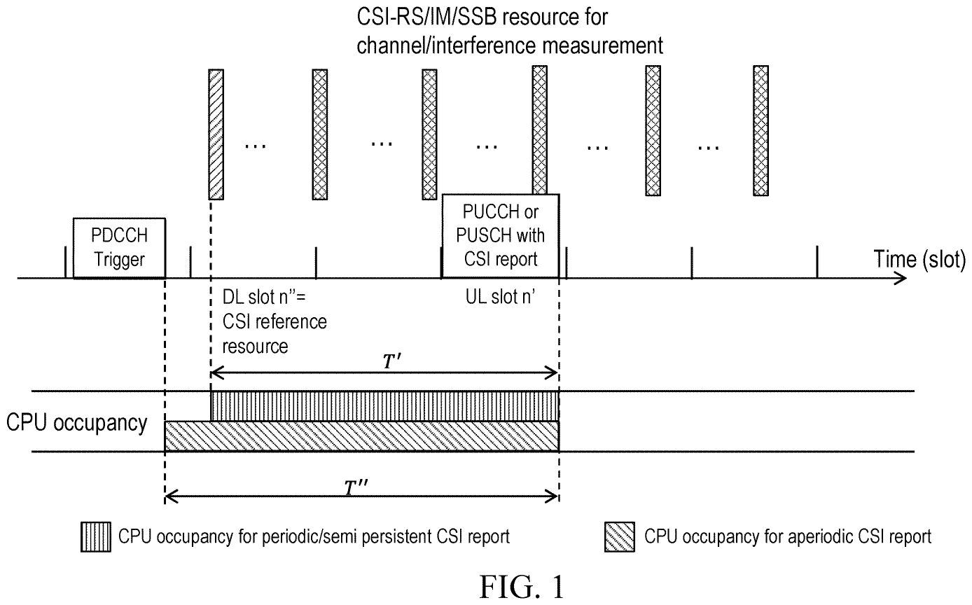

### DETAILED DESCRIPTION

Before describing in detail example embodiments, it is noted that the embodiments reside primarily in combinations of apparatus components and processing steps related to determining report processing unit(s) associated with reporting based on artificial intelligence and/or machine learning. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising.” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system.

Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

In some embodiments, the term CPU is used and may refer to CSI processing unit, which may be at least a portion of hardware and/or software (e.g., hardware and/or software resources) associated with processing of a CSI function (e.g., processing a CSI report, performing measurements, etc.). A CPU may be occupied for performing functions such as CSI function for a period of time, i.e., a CPU occupancy. CPU occupancy may also refer to resources (e.g., signaling resources, hardware/software resources, etc.) occupied for performing a CSI function.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

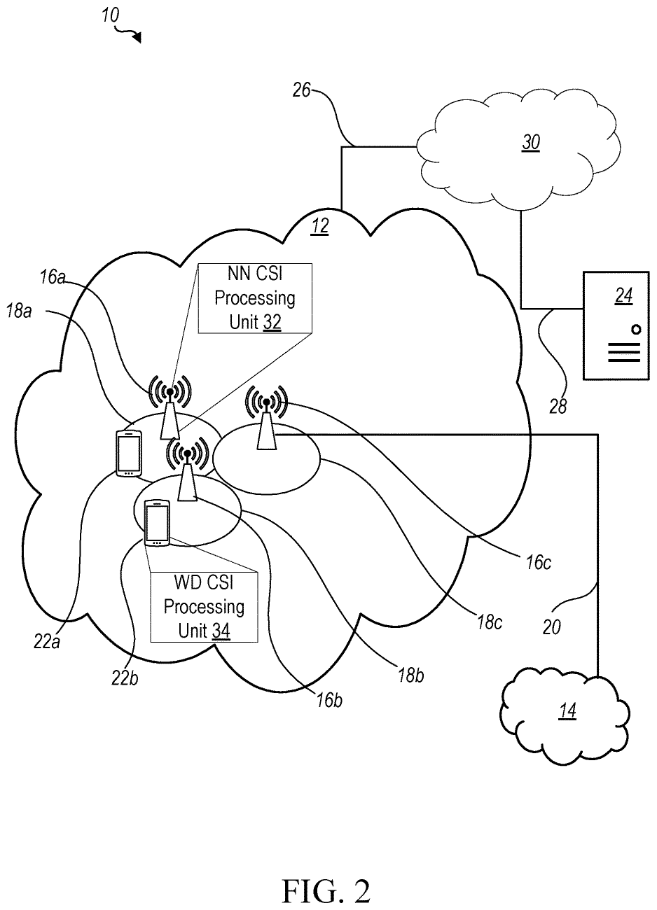

Referring again to the drawing figures, in which like elements are referred to by like reference numerals, there is shown in FIG. 2 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 2 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a NN CSI processing unit 32 which is configured to perform any step and/or task and/or process and/or method and/or feature described in the present disclosure, e.g., cause, based on a at least one of a first indication and second indication, the WD to determine at least a first channel state information (CSI) processing unit (CPU) of a first type of CPU based at least on a WD capability. A wireless device 22 is configured to include a WD CSI processing unit 34 which is configured to perform any step and/or task and/or process and/or method and/or feature described in the present disclosure, e.g., determine at least a first channel state information (CSI) processing unit (CPU) of a first type of CPU based at least on a WD capability, the first CPU of the first type being usable for determining a first CSI report, the first CSI report being based on at least one of an artificial intelligence process and a machine learning.

At least one of NN CSI processing unit 32 and WD CSI processing unit 34 may comprise at least one CSI processing unit (CPU), where at least one CPU is configured to perform one or more steps, e.g., steps associated with measuring and/or reporting (e.g., CSI calculations). In some embodiments, a CPU may be configured to perform one or more steps (e.g., a step associated with CSI such as a CSI calculation) and/or determine a report (e.g., CSI report) and/or cause transmission of a report (e.g., CSI report). A CPU may comprise, without being limited to, an AI CPU, an ML CPU, an AI/ML CPU, a legacy CPU, etc. A CPU may reside in (and/or be associated with a process including one or more steps performed by) hardware and/or software of WD 22 and/or NN 16.

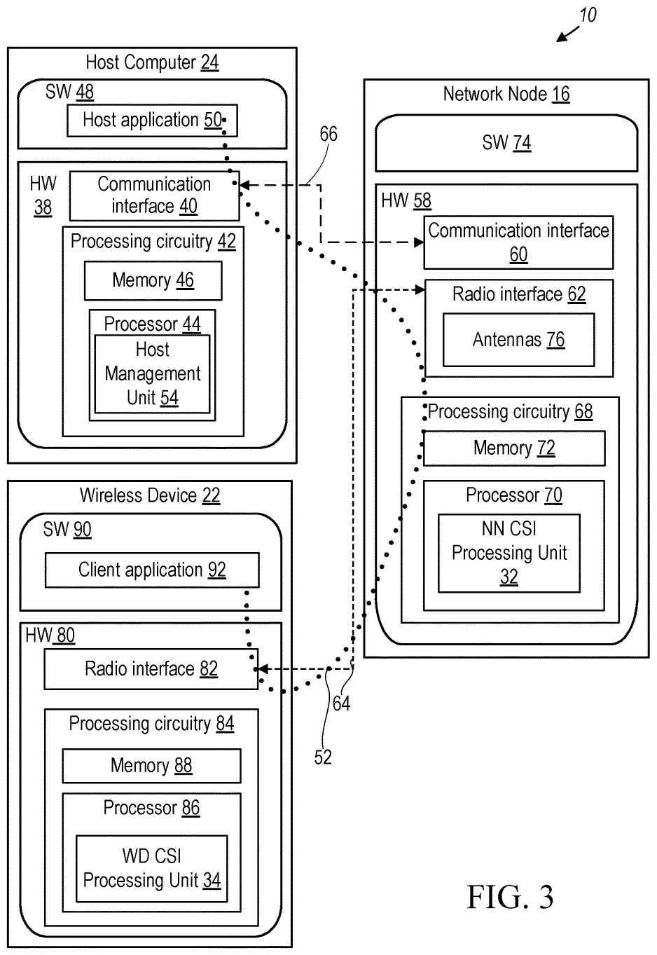

Example implementations, in accordance with an embodiment, of the WD 22, network node 16 and host computer 24 discussed in the preceding paragraphs will now be described with reference to FIG. 3. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include a host CSI processing unit 54 configured to perform any step and/or task and/or process and/or method and/or feature described in the present disclosure, e.g., enable the service provider to observe/monitor/control/transmit to/receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system and/or through one or more intermediate networks 30 outside the communication system 10).

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include NN CSI processing unit 32 which is configured to perform any step and/or task and/or process and/or method and/or feature described in the present disclosure, e.g., cause, based on a at least one of a first indication and second indication, the WD to determine at least a first channel state information (CSI) processing unit (CPU) of a first type of CPU based at least on a WD capability.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include WD CSI processing unit 34 which is configured to perform any step and/or task and/or process and/or method and/or feature described in the present disclosure, e.g., determine at least a first channel state information (CSI) processing unit (CPU) of a first type of CPU based at least on a WD capability, the first CPU of the first type being usable for determining a first CSI report, the first CSI report being based on at least one of an artificial intelligence process and a machine learning.

In some embodiments, the inner workings of the network node 16, WD 22, and host computer 24 may be as shown in FIG. 3 and independently, the surrounding network topology may be that of FIG. 2.

In FIG. 3, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 2 and 3 show various “units” such as NN CSI processing unit 32, and WD CSI processing unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

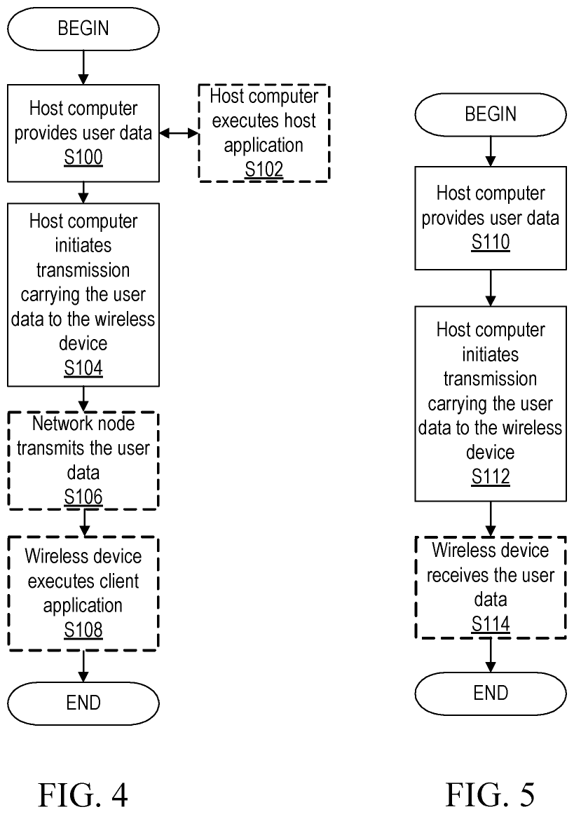

FIG. 4 is a flowchart illustrating an example method implemented in a communication system, such as, for example, the communication system of FIGS. 2 and 3, in accordance with one embodiment. The communication system may include a host computer 24, a network node 16 and a WD 22, which may be those described with reference to FIG. 3. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 5 is a flowchart illustrating an example method implemented in a communication system, such as, for example, the communication system of FIG. 2, in accordance with one embodiment. The communication system may include a host computer 24, a network node 16 and a WD 22, which may be those described with reference to FIGS. 2 and 3. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

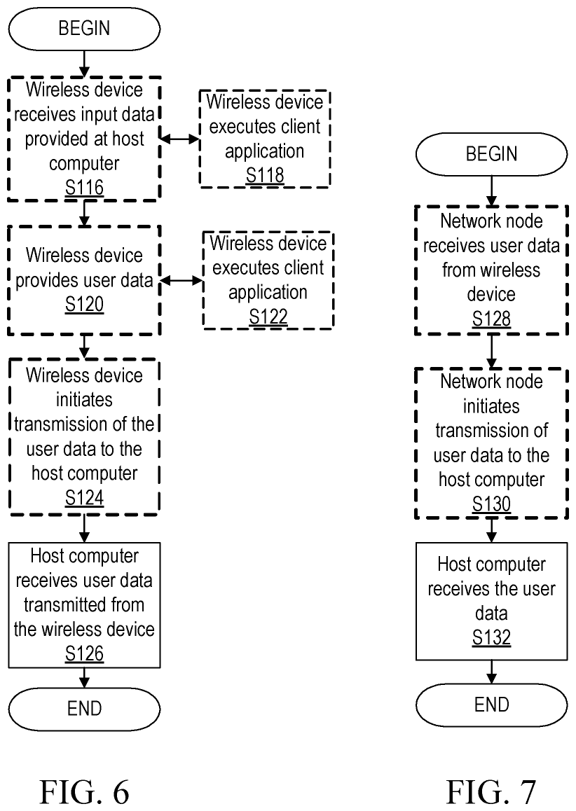

FIG. 6 is a flowchart illustrating an example method implemented in a communication system, such as, for example, the communication system of FIG. 2, in accordance with one embodiment. The communication system may include a host computer 24, a network node 16 and a WD 22, which may be those described with reference to FIGS. 2 and 3. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 7 is a flowchart illustrating an example method implemented in a communication system, such as, for example, the communication system of FIG. 2, in accordance with one embodiment. The communication system may include a host computer 24, a network node 16 and a WD 22, which may be those described with reference to FIGS. 2 and 3. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

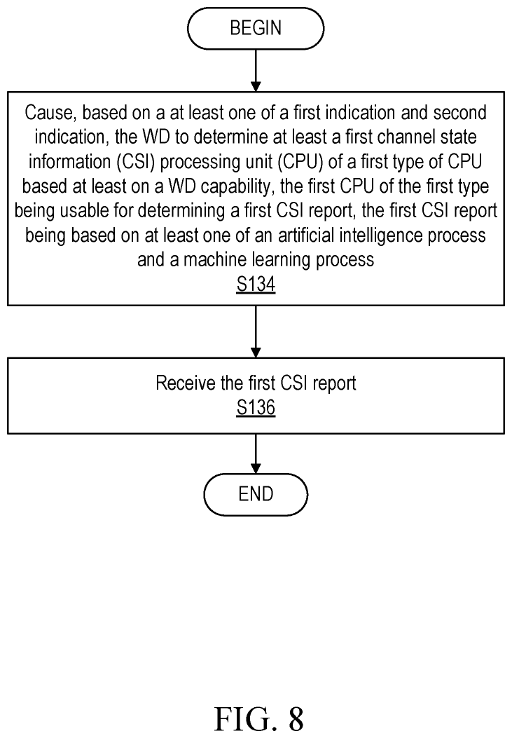

FIG. 8 is a flowchart of an example process (i.e., method) in a network node 16. One or more blocks described herein may be performed by one or more elements of network node 16 such as by one or more of processing circuitry 68 (including the NN CSI processing unit 32), processor 70, radio interface 62 and/or communication interface 60. Network node 16 such as via processing circuitry 68 and/or processor 70 and/or radio interface 62 and/or communication interface 60 is configured to cause (Block S134), based on a at least one of a first indication and second indication, the WD to determine at least a first channel state information (CSI) processing unit (CPU) of a first type of CPU based at least on a WD capability. The first CPU of the first type is usable for determining a first CSI report, and the first CSI report is based on at least one of an artificial intelligence process and a machine learning process. Further, the first CSI report is received (Block S136).

In some embodiments, the method further includes at least one of receiving the first indication indicating the WD capability of supporting the first type of CPU; and receiving the second indication indicating a maximum quantity of CPUs of the first type that the WD supports.

In some other embodiments, the method further includes receiving at least one of a second CSI report and a third CSI report. The second CSI report is determined using a second CPU of a second type, which is a legacy type of CPU. The third report includes the first and second CSI reports determined using the first and second CPUs, respectively.

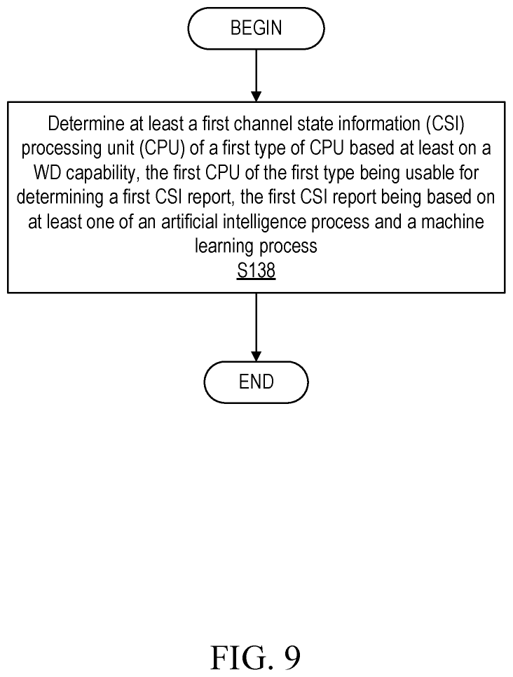

FIG. 9 is a flowchart of an example process (i.e., method) in a wireless device 22 according to some embodiments of the present disclosure. One or more blocks described herein may be performed by one or more elements of wireless device 22 such as by one or more of processing circuitry 84 (including the WD CSI processing unit 34), processor 86, radio interface 82 and/or communication interface 60. Wireless device 22 such as via processing circuitry 84 and/or processor 86 and/or radio interface 82 is configured to determine at least a first channel state information (CSI) processing unit (CPU) of a first type of CPU based at least on a WD capability, the first CPU of the first type being usable for determining a first CSI report, the first CSI report being based on at least one of an artificial intelligence process and a machine learning process.

In some embodiments, the method further includes at least one of determining a CPU occupancy based at least in part on the determined at least first CPU; and determining a CPU occupancy period associated at least with the first CPU.

In some other embodiments, the method further includes at least one of determining a first indication indicating the WD capability of supporting the first type of CPU; determining a second indication indicating a maximum quantity of CPUs of the first type that the WD supports; and transmitting at least one of the first and second indications.

In an embodiment, the method further includes determining a quantity of CPUs of the first type corresponding to a report quantity to determine the at least first CPU.

In another embodiment, the method further includes at least one of determining at least a second CPU of a second type, where the second CPU of the second type is usable for determining a second CSI report, the second type being a legacy type of CPU; and determining a CPU usage process for using the first CPU and the second CPU to determine a third CSI report. The third report includes the first and second CSI reports determined using the first and second CPUs, respectively.

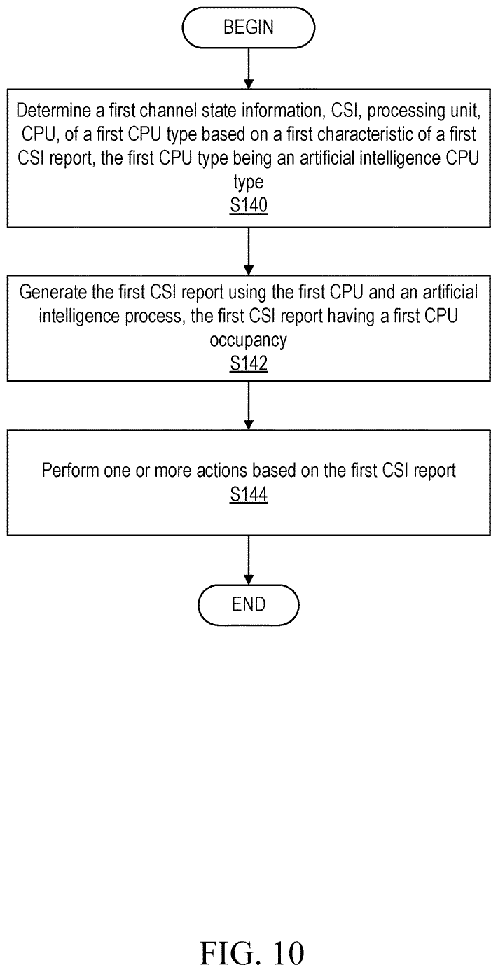

FIG. 10 is a flowchart of an example process (i.e., method) in a wireless device 22 according to some embodiments of the present disclosure. One or more blocks described herein may be performed by one or more elements of wireless device 22 such as by one or more of processing circuitry 84 (including the WD CSI processing unit 34), processor 86, radio interface 82 and/or communication interface 60. Wireless device 22 such as via processing circuitry 84 and/or processor 86 and/or radio interface 82 is configured to determine (Block S140) a first channel state information (CSI) processing unit (CPU) of a first CPU type based on a first characteristic of a first CSI report, where the first CPU type is an artificial intelligence CPU type, and generate (Block S142) the first CSI report using the first CPU and an artificial intelligence process, where the first CSI report has a first CPU occupancy. One or more actions are performed (Block S144) based on the first CSI report.

In some embodiments, the method further includes at least one of: (A) determining a second CPU of a second CPU type based on a second characteristic of a second CSI report, where the second CPU type and the first CPU type are different; (B) generating the second CSI report using the second CPU, where the second CSI report has a second CPU occupancy; and (C) performing the one or more actions further based on the second CSI report.

In some other embodiments, performing the one or more actions includes transmitting at least one of the first CSI report and the second CSI report to the network node 16.

In some embodiments, at least one of: (A) the first CPU occupancy includes a first CPU occupancy period; (B) the first CPU occupancy period starts after a time offset relative to a trigger signal transmitted by the network node 16; and (C) the second CPU occupancy includes a second CPU occupancy period.

In some other embodiments, the first CPU occupancy period overlaps at least in part with the second CPU occupancy period.

In some embodiments, the method further includes determining a total CPU occupancy period based on the first CPU occupancy period and the second CPU occupancy period.

In some other embodiments, the first CPU occupancy includes a quantity of CPUS of the first CPU type that the first CSI report occupies to generate the first CSI report.

In some embodiments, the method further includes determining a third CPU of the first CPU type based on at least in part on the quantity of CPUs of the first CPU type that the first CSI report occupies, the first CSI report being generated further using the third CPU.

In some other embodiments, the method further includes at least one of: (A) determining a first indication indicating a WD capability of supporting the first CPU type; (B) determining a second indication indicating a maximum quantity of CPUs of the first CPU type supported by the WD 22; (C) determining a third indication indicating a maximum quantity of CSI calculations supported by the WD 22; and (D) transmitting at least one of the first indication, the second indication, and the third indication to the network node 16.

In some other embodiments, the method further includes, in response to at least one of the first indication, the second indication, and the third indication, receiving, from the network node, signaling usable by the WD 22 to generate at least the first CSI report using the first CPU.

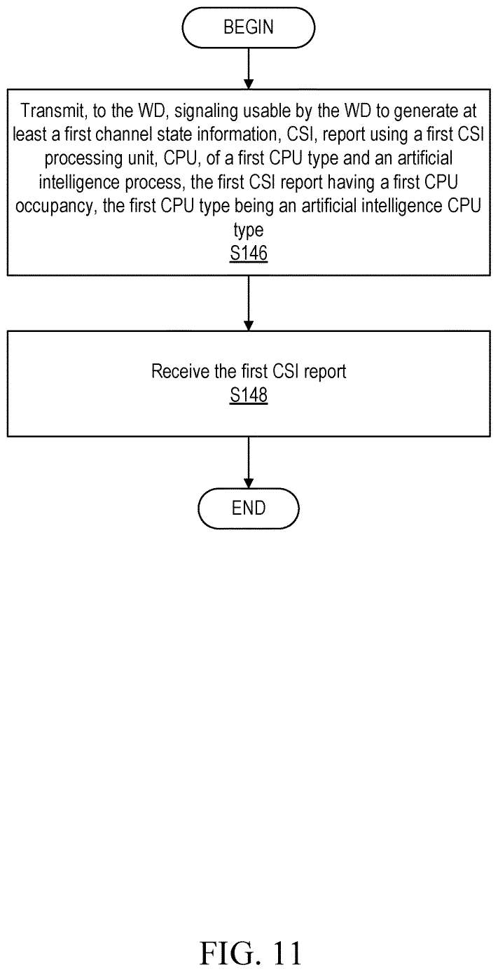

FIG. 11 is a flowchart of an example process (i.e., method) in a network node 16. One or more blocks described herein may be performed by one or more elements of network node 16 such as by one or more of processing circuitry 68 (including the NN CSI processing unit 32), processor 70, radio interface 62 and/or communication interface 60. Network node 16 such as via processing circuitry 68 and/or processor 70 and/or radio interface 62 and/or communication interface 60 is configured to transmit (Block S146), to the WD 22, signaling usable by the WD 22 to generate at least a first channel state information (CSI) report using a first CSI processing unit (CPU) of a first CPU type and an artificial intelligence process, where the first CSI report has a first CPU occupancy, and the first CPU type is an artificial intelligence CPU type. Network node 16 is further configured to receive (Block S148) the first CSI report.

In some embodiments, the signaling is usable by the WD 22 to further generate a second CSI report using a second CPU of a second CPU type. The second CSI report has a second CPU occupancy, and the second CPU type and the first CPU type are different.

In some other embodiments, the method further includes receiving the second CSI report from the WD 22.

In some embodiments, at least one of: (A) the first CPU occupancy includes a first CPU occupancy period; (B) the first CPU occupancy period starts after a time offset relative to a trigger signal transmitted by the network node; and (C) the second CPU occupancy includes a second CPU occupancy period.

In some other embodiments, the first CPU occupancy period overlaps at least in part with the second CPU occupancy period.

In some embodiments, a total CPU occupancy period is based on the first CPU occupancy period and the second CPU occupancy period.

In some other embodiments, the first CPU occupancy includes a quantity of CPUs of the first CPU type that the first CSI report occupies to generate the first CSI report.

In some embodiments, the signaling is usable by the WD 22 to further generate the first CSI report using a third CPU of the first CPU type based on at least in part on the quantity of CPUs of the first CPU type that the first CSI report occupies.

In some other embodiments, the method further includes at least one of: (A) receiving a first indication indicating a WD capability of supporting the first CPU type; (B) receiving a second indication indicating a maximum quantity of CPUs of the first CPU type supported by the WD 22; and (C) receiving a third indication indicating a maximum quantity of CSI calculations supported by the WD 22.

In some embodiments, the maximum quantity of CSI calculations includes at least one of: (A) a quantity of simultaneous CSI reports per component carrier to be generated using the artificial intelligence process; and (B) another quantity of simultaneous CSI reports for a plurality component carriers to be generated using the artificial intelligence process.

Having described the general process flow of arrangements of the disclosure and having provided examples of hardware and software arrangements for implementing the processes and functions of the disclosure, the sections below provide details and examples of arrangements for determining report processing unit(s) associated with reporting based on artificial intelligence and/or machine learning.

In some embodiments, artificial intelligence refers to machine learning. In some other embodiments, a CSI processing unit (CPU) or more are included in WD CSI Processing Unit 34, e.g., WD CSI Processing Unit 34 is configured to perform CPU functions. However, the embodiments are not limited as such, and a CPU or more may be included in any of the units of the network node 16 and host computer 24.

### Introduction of New Types of CPU for AI ML

For AI/ML-based CSI processing (including but not limited to channel measurement/estimation, beam reporting, PMI calculation, etc.), a dedicated processing unit (i.e., CPU associated with NN CSI processing unit 32 and/or WD CSI processing unit 34) may be used for processing reports, e.g., other than for processing the legacy CSI report. In this case, new types of CPU can be defined, in order to handle the CSI processing timeline for AI/ML-based CSI.

In some embodiments, the dedicated processing unit may be used for processing legacy CSI reports. In some embodiments, the term “characteristic” of a CSI report is used and may refer to information usable to determine a CPU type. The information may include, for example, information about a requirement for generating a CSI report, such as a requirement for an artificial intelligence process to be performed to determine at least one parameter and/or information of the CSI report. In some other embodiments, the term action is used and may refer to performing any of the steps described herein such as transmission/reception of signaling associated with or in response to the determination of CPUs, generation of CSI reports, etc.

For example, the WD 22 may transmit an indication to the network node, e.g., using WD capability signaling indicating that WD 22 supports an AI-CPU type, which may be used to capture (i.e., perform) the AI/ML based processing. In some embodiments, if the WD 22 reports the WD capability, the WD 22 may comprise dedicated hardware and software, e.g., WD CSI processing unit 34, to run the AI/ML based operations (such as a neural network engine). The legacy CPU and AI-CPU may be used in parallel for (or by) WD 22, where an AI/ML based CSI report such as CSI prediction or CSI compression may use the AI-CPU, while legacy CSI reporting may use the legacy framework with CPU.

In this case, the WD 22 may also indicate to the network node 16 the maximum number of simultaneous AI/ML-based CSI calculations WD 22 can support, e.g., denoted by N_{AI-CSI}. The maximum number may be for each component carrier and/or across all component carriers. The maximum numbers could be indicated to the network node 16 (e.g., gNB) via parameters:
simultaneousCSI-ReportsPerCC-AIML in a component carrier
simultaneousCSI-ReportsAllCC-AIML across all component carriers

Further, it is possible that multiple AI/ML models may need to be implemented to support multiple sub-use case. For example, CSI compression and CSI prediction are two different CSI sub-use cases but may not share the same AI/ML model. Thus, the number of CSI calculations supported for each of such sub-use cases may be separately defined, where one parameter is for one component carrier, and another parameter is for the total across all component carriers. For instance, the WD 22 indicates for AI/ML based CSI processing:
For CSI compression:
   parameter simultaneousCSI-ReportsPerCC-Compression-AIML in a component carrier, and
   parameter simultaneousCSI-ReportsAllCC-Compression-AIML across all component carriers
For CSI prediction:
   parameter simultaneousCSI-ReportsPerCC-Prediction-AIML in a component carrier, and
   parameter simultaneousCSI-ReportsAllCC-Prediction-AIML across all component carriers.

Additionally, the total number of CSI processing supported across all processing may be capped by a parameter, for example:
parameter simultaneousCSI-ReportsPerCC-all in a component carrier, which defines the maximum number of simultaneous CSI calculations in a component carrier which is supported by both AI/ML and legacy processors.
parameter simultaneousCSI-ReportsAllCC-all across all component carriers, which defines the maximum number of simultaneous CSI calculations across all component carriers which is supported by both AI/ML and legacy processor.

Processing of a CSI report may occupy a number of AI-CPUs, denoted as O_{AI-CPU}, where O_{AI-CPU} is an integer and O_{AI-CPU}≥1. The counting of occupied AI-CPU may use one of the alternatives below or use them in a combination.
In one example, one AI-CPU is designed to process one set of measurements at a time, similar to legacy CPU. Then the value of O_{AI-CPU} may be defined as a function of reportQuantities, number of CSI-RS ports and/or the number of configured CSI-RS resources. For instance, O_{AI-CPU} is equal to the number of CSI-RS resources in the CSI-RS resource set for channel measurement.
In another example, one type of AI-CPU is designed for one AI/ML functionality. For instance, one type of AI-CPU is implemented to handle beam prediction, a second type of AI-CPU is implemented to handle CSI compression, a third type of AI-CPU is implemented to handle CSI prediction. Thus, the value of O_{AI-CPU} is the summation of occupied AI-CPU of all three types.

In addition, the time period over which an AI-CPU is occupied may also be defined. The occupancy period for AI-CPU may depend on one or multiple of the following:
Starting time of AI-CPU occupation:
   Triggering time of CSI report, for example, the first symbol after the PDCCH triggering the CSI report:
   CSI-RS/CSI-IM/SSB resource in time domain, e.g., first symbol of the earliest one of each CSI-RS/CSI-IM/SSB resource for channel or interference measurement, respective the latest CSI-RS/CSI-IM/SSB occasion no later than the corresponding CSI reference resource:
   CSI reference resource of the given CSI report, either on PUCCH or PUSCH,
End time of AI-CPU occupation:
   The last symbol of the UL physical channel that carries the CSI report (e.g., PUSCH, PUCCH).

The WD 22 may not need to calculate, determine, or generate an updated AI-CSI report if the total AI-CPU occupancy exceeds N_{AI-CSI} at a given time instance. However, the WD 22 may transmit dummy bits or a previous CSI (or AI-CSI) report (i.e., no update), e.g., in order to keep the rate matching procedure for PUSCH and/or PUCCH unaffected (this avoids NN 16 (e.g., gNB) receiver confusion about how to receive the PUSCH and/or PUCCH).

CPU Definition Restriction when AI ML Based CSI Processing Coexists with Legacy Processing

Note that the ReportQuantity may also contain a mix of legacy CSI and AI-CSI, such as both CSI-RS Resource Indicator (CRI) (selecting and reporting CSI-RS resource, which is performed using legacy methods) and COIPredict, which use the AI/ML model in the WD 22. In this case, values of O_{CPU} for legacy CPU may be introduced, which account for calculating only a subset of the configured report quantities. Similarly, additional values of O_{AI-CPU} may be introduced, which account for calculating only a subset of the configured report quantities. Rules may be standardized when both legacy CPU and AI-CPU are used for calculating a configured report quantity.

In this case, the WD 22 may indicate to the NN 16 the maximum number of simultaneous CSI calculations, for example denoted by N_{TOTAL-CPU}, when both legacy CPU and AI-CPU are used. In addition, the WD 22 may also indicate the maximum number of simultaneous CSI calculations for AI-CPU and legacy CPU individually, e.g., N_{AI-CPU} and N_{CPU} respectively, when both are being used for deriving a CSI report. Then N_{AI-CPU} is a number less than or equal to N_{AI-CPU}, while N_{CPU} is a number less than or equal to N_{CPU}. All the above maximum numbers could be defined for each component carrier and/or across all component carriers.

Furthermore, the time period over which the AI-CPU and the legacy CPU are occupied may also be defined/modified when both are being used for calculating a configured reportQuantity or a CSI report.
The union of the AI-CPU occupancy period and the legacy CPU occupancy period may be defined, which can depend on one or multiple of the following: triggering time of CSI report, CSI-RS resource occurrence in time domain, CSI-RS reference resource, or an UL physical channel that carries the report (e.g., PUSCH, PUCCH). However, the occupancy periods for legacy CSI and AI-CSI may or may not overlap in time.
The legacy CPU occupancy period (either starting time, or ending time, or both) may be defined/modified, which can depend on one or multiple of the following: triggering time of CSI report, CSI-RS resource occurrence in time domain, CSI-RS reference resource, or an UL physical channel that carries the report (e.g., PUSCH, PUCCH). For example, the ending time of a legacy CPU occupancy period may be at the last symbol of configured RS resource for measurement, possibly with a pre-determined offset.
The AI-CPU occupancy period (either starting time, or ending time, or both) may be defined/modified, which can depend on one or multiple of the following: triggering time of CSI report, CSI-RS resource occurrence in time domain, CSI-RS reference resource, or an UL physical channel that carries the report (e.g., PUSCH, PUCCH). For example, the starting time of an AI-CPU occupancy period may be at a pre-defined offset from the PDCCH triggering of CSI report.

The above is further explained below with some nonlimiting examples.

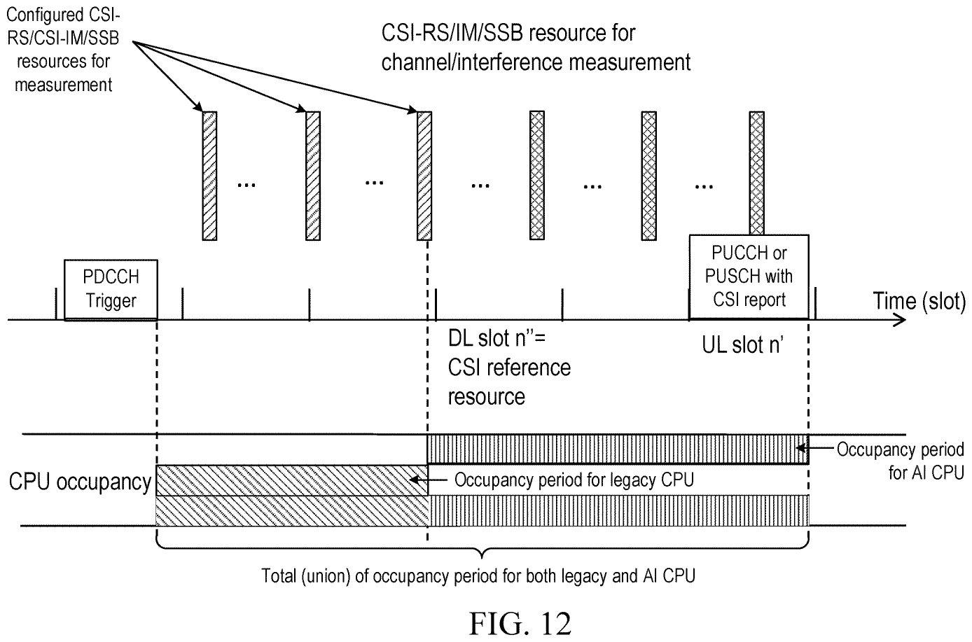

In the first example, if reportQuantity is configured as ‘cri-RI-PMI-CQI’, and the legacy CPU is used for calculating CRI, while the AI-CPU is used for calculating the remaining quantities (i.e., RI, PMI, CQI), then the legacy CPU occupancy period can be from the first symbol after the PDCCH triggering of report, e.g., until receiving the last CSI-RS resource for channel/interference measurement, while the AI-CPU occupancy period can be defined as from the first symbol after the end of legacy CPU occupancy period, until the last symbol of PUCCH/PUSCH carrying the CSI report etc. FIG. 12 shows an example CPU occupancy period when both legacy and AI-CPU are used for calculating, determining, and/or generating a CSI report. More specifically, FIG. 12 shows an example of an CPU occupancy period when both legacy CPU and AI-CPU are used for calculating a configured reportQuantity with aperiodic CSI report.

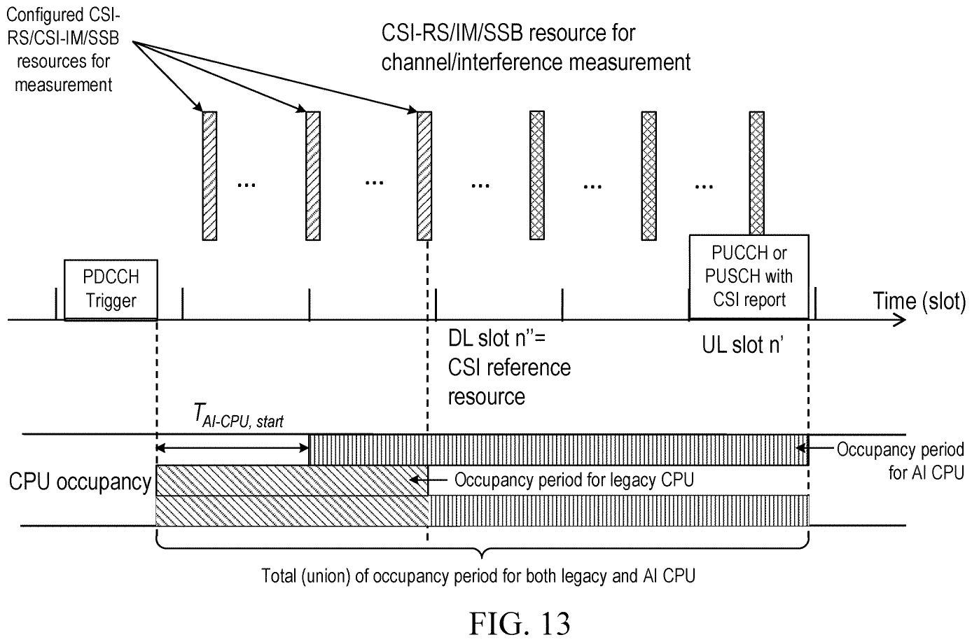

In another example, the legacy CPU and AI-CPU may overlap for some duration as shown in FIG. 13. More specifically, CPU occupancy period when both legacy CPU and AI-CPU used for calculating a configured reportQuantity are shown. This corresponds to the case where the WD 22 starts the AI-CSI engine after measuring a few of the samples of CSI-RS/CSI-IM/SSB and performs parallel processing between the legacy CSI and AI-CSI engines. The legacy CPU is occupied from the start of the last symbol of the PDCCH carrying the trigger until the last symbol of the last CSI-RS/CSI-IM/SSB resource, not later than the CSI reference resource used for channel/interference measurement. Since both the WD 22 and the NN 16 (e.g., gNB) may need to know the occupancy periods for legacy CPU and AI CPU, the start of the occupancy period for AI-CPU may be defined. An offset TAI-CPU, sturt may be defined with respect to the last symbol of the PDCCH carrying the trigger to indicate where the occupancy period for AI-CPU will start. Besides the above-mentioned pre-defined starting time of AI-CPU and legacy CPU when both are being used, it can also be indicated to the NN 16 (e.g., gNB) by the WD 22. In some embodiments, TAI-CPU, start may be indicated as a WD capability to the NN 16 (e.g., gNB).

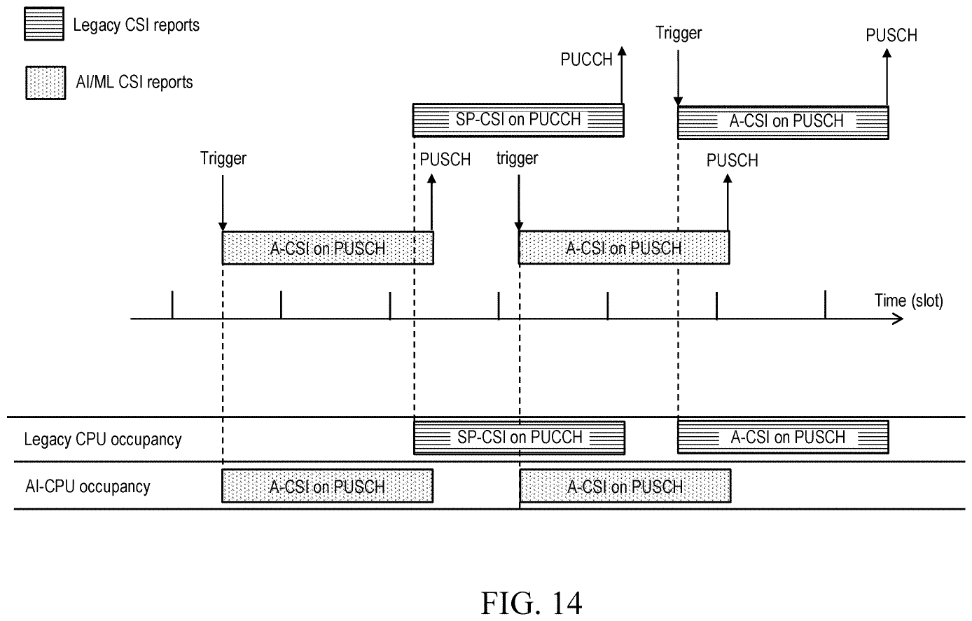

In still another example, the legacy CPU(s) and AI-CPU(s) are managed independently, as shown in FIG. 14. The CSI reports are categorized into (a) legacy CSI reports and (b) AI/ML based CSI reports. Legacy CSI reports are processed by legacy CPU(s), and AI/ML based CSI reports are processed by AI-CPU(s). These two branches may be handled independently, e.g., the counting of occupied legacy CPUs is independent from the counting of AI-CPUs, the number of supported legacy CPU(s) is reported independent from the number of supported AI-CPU(s), etc.

Further, AI/ML CSI reports may be generated and/or determined and/or processed based on and/or in response to a trigger signal (e.g., PDCCH trigger). The duration of the processing (e.g., CPU occupancy) may be bound by the trigger signal and a PUSCH. Other reports, such as legacy CSI reports, may be generated and/or determined and/or processed based on and/or prior to transmission of a PUSCH. The duration of the processing (e.g., CPU occupancy) of the legacy CSI report may be bound by a time prior to the transmission of PUSCH and the transmission of a PUCCH. The AI/ML CSI report may include an aperiodic CSI (A-CSI) transmittable on a PUSCH. The legacy CSI report may include a semi-persistent CSI (SP-CSI) transmittable on PUSCH. The processing or occupancy of each one of the AI/ML CSI reports and the legacy CSI reports may at least partially overlap in time.

In some embodiments, at a given time instance, the WD 22 may not need to calculate a CSI report if one or multiple of the following is fulfilled:
The total number of AI-CPU occupancy and legacy CPU occupancy exceeds N_{TOTAL-CPU};
The total number of AI-CPU occupancy exceeds N′_{AI-CPU};
The total number of legacy CPU occupancy exceeds N′_{CPU}.

In the above scenario, the WD 22 may still transmit dummy bits or a previous CSI report, in order to keep the rate matching procedure for PUSCH and/or PUCCH. In some embodiments, when the total number of AI-CPU occupancy exceeds N_{AI-CPU}, the WD 22 is not required to update a subset of AI-CSIs based on priority order (i.e., a subset of AI-CSIs with lower priority may not need to be updated). Note that in order for the WD 22 to compute CSI and report updated CSI, the above criteria have to be met for both (i) independent occupancy of legacy CPU and AI-CPU, and (ii) mixed usage of legacy CPU and AI-CPU for a CSI report.

In addition, additional criteria may be defined on the total number of AI-CPU occupancy over all CCs (component carriers). When the total number of AI-CPUs occupied over all CCs exceeds the total number of AI-CPU occupancy over all CCs, the WD 22 is not required to update a subset of AI-CSIs based on priority order (i.e., a subset of AI-CSIs with lower priority may not need to be updated).

CSI Computation Delay when AI ML Based CSI Processing Coexist with Legacy Processing

When AI/ML based CSI processing is specified in addition to legacy CSI processing for NR, then the WD CSI computation time may be modified (e.g., enhanced). In one embodiment, features such as “L=0 CPUs”, “X CSI-RS reports”, etc. refer to the legacy CSI processing only, i.e., AI/ML processing is excluded.

Exemplary conditions in CSI computation time are described. For example, the conditions provided below for determining that CSI computation delay may follow the faster time (Z₁, Z_{1′}) of the Table 5.4-1 of 3GPP TS 38.214 (referred to herein as “table 5.4-1”). When both AI/ML based processing and legacy processing exist, then the conditions may be limited to legacy processing only, e.g., M is the number of updated CSI report(s) processed by legacy (non-AI/ML) procedure; L=0 CPUs are occupied by legacy (non-AI/ML) procedure.

The following is an excerpt of 3GPP TS 38.214, section 5.4:

$$Z = {max}_{m = 0 , … , M - 1} ( Z ( m ) ) and {Z}^{′} = {max}_{m = 0 , … , M - 1} ( {Z}^{′} ( m ) ) ,$$

where M is the number of updated CSI report(s) according to Clause 5.2.1.6, (Z(m), Z′(m)) corresponds to the m-th updated CSI report and is defined as
(Z₁, Z′₁) of the table 5.4-1 if max {μ_{PDCCH}, μ_{CSI-RS}, μ_{UL}}≤3 and if the CSI is triggered without a PUSCH with either transport block or HARQ-ACK or both when L=0 CPUs are occupied (according to 3GPP) and the CSI to be transmitted is a single CSI and corresponds to wideband frequency-granularity where the CSI corresponds to at most 4 CSI-RS ports in a single resource without CRI report and where CodebookType is set to ‘typel-SinglePanel’ or where reportQuantity is set to ‘cri-RI-CQI’.

The following is a nonlimiting list of example embodiments.

### Embodiment A1

A network node configured to communicate with a wireless device (WD), the network node configured to, and/or comprising a radio interface and/or comprising processing circuitry configured to:
cause, based on a at least one of a first indication and second indication, the WD to determine at least a first channel state information (CSI) processing unit (CPU) of a first type of CPU based at least on a WD capability, the first CPU of the first type being usable for determining a first CSI report, the first CSI report being based on at least one of an artificial intelligence process and a machine learning process; and
receive the first CSI report.

### Embodiment A2

The network node of Embodiment A1, the radio interface is configured to at least one of:
receive the first indication indicating the WD capability of supporting the first type of CPU; and
receive the second indication indicating a maximum quantity of CPUs of the first type that the WD supports.

### Embodiment A3

The network node of Embodiment A1 and A2, the radio interface is further configured to:
receive at least one of a second CSI report and a third CSI report, the second CSI report being determined using a second CPU of a second type, the second type being a legacy type of CPU, the third report including the first and second CSI reports determined using the first and second CPUs, respectively.

### Embodiment B1

A method implemented in a network node, the method comprising:
causing, based on a at least one of a first indication and second indication, the WD to determine at least a first channel state information (CSI) processing unit (CPU) of a first type of CPU based at least on a WD capability, the first CPU of the first type being usable for determining a first CSI report, the first CSI report being based on at least one of an artificial intelligence process and a machine learning process; and
receiving the first CSI report.

### Embodiment B2

The method of Embodiment B1, the method further includes at least one of:
receiving the first indication indicating the WD capability of supporting the first type of CPU; and
receiving the second indication indicating a maximum quantity of CPUs of the first type that the WD supports.

### Embodiment B3

The method of Embodiment B1 and B2, the method further includes:
receiving at least one of a second CSI report and a third CSI report, the second CSI report being determined using a second CPU of a second type, the second type being a legacy type of CPU, the third report including the first and second CSI reports determined using the first and second CPUs, respectively.

### Embodiment C1

A wireless device (WD) configured to communicate with a network node, the WD configured to, and/or comprising a radio interface and/or processing circuitry configured to:
determine at least a first channel state information (CSI) processing unit (CPU) of a first type of CPU based at least on a WD capability, the first CPU of the first type being usable for determining a first CSI report, the first CSI report being based on at least one of an artificial intelligence process and a machine learning process.

### Embodiment C2

The WD of Embodiment C1, wherein the processing circuitry is further configured to at least one of:
determine a CPU occupancy based at least in part on the determined at least first CPU; and
determine a CPU occupancy period associated at least with the first CPU.

### Embodiment C3

The WD of any one of Embodiments C1 and C2, wherein the processing circuitry is further configured to at least one of:
determine a first indication indicating the WD capability of supporting the first type of CPU:
determine a second indication indicating a maximum quantity of CPUs of the first type that the WD supports; and
cause transmission of at least one of the first and second indications.

### Embodiment C4

The WD of any one of Embodiments C1-C3, wherein the processing circuitry is further configured to:
determine a quantity of CPUs of the first type corresponding to a report quantity to determine the at least first CPU.

### Embodiment C5

The WD of any one of Embodiments C1-C4, wherein the processing circuitry is further configured to at least one of:
determine at least a second CPU of a second type, the second CPU of the second type being usable for determining a second CSI report, the second type being a legacy type of CPU; and
determine a CPU usage process for using the first CPU and the second CPU to determine a third CSI report, the third report including the first and second CSI reports determined using the first and second CPUs, respectively.

### Embodiment D1

A method in a wireless device (WD) configured to communicate with a network node, the method comprising:
determining at least a first channel state information (CSI) processing unit (CPU) of a first type of CPU based at least on a WD capability, the first CPU of the first type being usable for determining a first CSI report, the first CSI report being based on at least one of an artificial intelligence process and a machine learning process.

### Embodiment D2

The method of Embodiment D1, wherein the method further includes at least one of:
determining a CPU occupancy based at least in part on the determined at least first CPU; and
determining a CPU occupancy period associated at least with the first CPU.

### Embodiment D3

The method of any one of Embodiments D1 and D2, wherein the method further includes at least one of:
determining a first indication indicating the WD capability of supporting the first type of CPU:
determining a second indication indicating a maximum quantity of CPUs of the first type that the WD supports; and
transmitting at least one of the first and second indications.

### Embodiment D4

The method of any one of Embodiments D1-D3, wherein the method further includes:
determining a quantity of CPUs of the first type corresponding to a report quantity to determine the at least first CPU.

### Embodiment D5

The method of any one of Embodiments D1-D4, wherein the method further includes at least one of:
determining at least a second CPU of a second type, the second CPU of the second type being usable for determining a second CSI report, the second type being a legacy type of CPU; and
determining a CPU usage process for using the first CPU and the second CPU to determine a third CSI report, the third report including the first and second CSI reports determined using the first and second CPUs, respectively.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
3GPP 3rd Generation Partnership Project
5G Fifth Generation
ACK Acknowledgement
AI Artificial Intelligence
CSI Channel State Information
CSI-RS CSI Reference Signal
DCI Downlink Control Information
DoA Direction of Arrival
DL Downlink
DMRS Downlink Demodulation Reference Signals
FDD Frequency-Division Duplex
FR2 Frequency Range 2
HARQ Hybrid Automatic Repeat Request
ID identity
gNB gNodeB
MAC Medium Access Control
MAC-CE MAC Control Element
ML Machine Learning
NR New Radio
NW Network
OFDM Orthogonal Frequency Division Multiplexing
PDCCH Physical Downlink Control Channel
PDSCH Physical Downlink Shared Channel
PRB Physical Resource Block
QCL Quasi co-located
RB Resource Block
RRC Radio Resource Control
RSRP Reference Signal Received Power
RSRQ Reference Signal Received Quality
RSSI Received Signal Strength Indicator
SCS Subcarrier Spacing
SINR Signal to Interference plus Noise Ratio
SRS Sounding Reference Signal
SSB Synchronization Signal Block
RS Reference Signal
Rx Receiver
TB Transport Block
TDD Time-Division Duplex
TCI Transmission configuration indication
TRP Transmission/Reception Point
Tx Transmitter
UE User Equipment
UL Uplink

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A wireless device, WD, configured to communicate with a network node, the WD configured to:
determine a first channel state information, CSI, processing unit, CPU, of a first CPU type based on a first characteristic of a first CSI report, the first CPU type being an artificial intelligence CPU type;
generate the first CSI report using the first CPU and an artificial intelligence process, the first CSI report having a first CPU occupancy; and
perform one or more actions based on the first CSI report.

2. The WD of claim 1, wherein the WD is further configured to at least one of:
determine a second CPU of a second CPU type based on a second characteristic of a second CSI report, the second CPU type and the first CPU type being different;
generate the second CSI report using the second CPU, the second CSI report having a second CPU occupancy; and
perform the one or more actions further based on the second CSI report.

3. The WD of claim 2, wherein performing the one or more actions includes:
transmitting at least one of the first CSI report and the second CSI report to the network node.

4. The WD of claim 2, wherein at least one of:
the first CPU occupancy includes a first CPU occupancy period;
the first CPU occupancy period starts after a time offset relative to a trigger signal transmitted by the network node; and
the second CPU occupancy includes a second CPU occupancy period.

5. The WD of claim 4, wherein the first CPU occupancy period overlaps at least in part with the second CPU occupancy period.

6. The WD of claim 4, wherein the WD is further configured to:
determine a total CPU occupancy period based on the first CPU occupancy period and the second CPU occupancy period.

7. The WD of claim 1, wherein the first CPU occupancy includes a quantity of CPUs of the first CPU type that the first CSI report occupies to generate the first CSI report.

8. The WD of claim 7, wherein the WD is further configured to:
determine a third CPU of the first CPU type based on at least in part on the quantity of CPUs of the first CPU type that the first CSI report occupies, the first CSI report being generated further using the third CPU.

9. The WD of claim 1, wherein the WD is further configured to at least one of:
determine a first indication indicating a WD capability of supporting the first CPU type;
determine a second indication indicating a maximum quantity of CPUs of the first CPU type supported by the WD;
determine a third indication indicating a maximum quantity of CSI calculations supported by the WD; and
transmit at least one of the first indication, the second indication, and the third indication to the network node.

10. The WD of claim 9, wherein the WD is further configured to, in response to at least one of the first indication, the second indication, and the third indication:
receive, from the network node, signaling usable by the WD to generate at least the first CSI report using the first CPU.

11. A method in a wireless device, WD, configured to communicate with a network node, the method comprising:
determining a first channel state information, CSI, processing unit, CPU, of a first CPU type based on a first characteristic of a first CSI report, the first CPU type being an artificial intelligence CPU type;
generating the first CSI report using the first CPU and an artificial intelligence process, the first CSI report having a first CPU occupancy; and
performing one or more actions based on the first CSI report.

12. The method of claim 11, wherein the method further includes at least one of:
determining a second CPU of a second CPU type based on a second characteristic of a second CSI report, the second CPU type and the first CPU type being different;
generating the second CSI report using the second CPU, the second CSI report having a second CPU occupancy; and
performing the one or more actions further based on the second CSI report.

13. The method of claim 12, wherein performing the one or more actions includes:
transmitting at least one of the first CSI report and the second CSI report to the network node.

14. The method of claim 12, wherein at least one of:
the first CPU occupancy includes a first CPU occupancy period;
the first CPU occupancy period starts after a time offset relative to a trigger signal transmitted by the network node; and
the second CPU occupancy includes a second CPU occupancy period.

15. The method of claim 14, wherein the first CPU occupancy period overlaps at least in part with the second CPU occupancy period.

16. The method of claim 14, wherein the method further includes:
determining a total CPU occupancy period based on the first CPU occupancy period and the second CPU occupancy period.

17. The method of claim 11, wherein the first CPU occupancy includes a quantity of CPUs of the first CPU type that the first CSI report occupies to generate the first CSI report.

18. The method of claim 17, wherein the method further includes:
determining a third CPU of the first CPU type based on at least in part on the quantity of CPUs of the first CPU type that the first CSI report occupies, the first CSI report being generated further using the third CPU.

19. (canceled)

20. (canceled)

21. A network node configured to communicate with a wireless device, WD, the network node configured to:
transmit, to the WD, signaling usable by the WD to generate at least a first channel state information, CSI, report using a first CSI processing unit, CPU, of a first CPU type and an artificial intelligence process, the first CSI report having a first CPU occupancy, the first CPU type being an artificial intelligence CPU type; and
receive the first CSI report.

22-30. (canceled)

31. A method in a network node configured to communicate with a wireless device, WD, the method comprising:
transmitting, to the WD, signaling usable by the WD to generate at least a first channel state information, CSI, report using a first CSI processing unit, CPU, of a first CPU type and an artificial intelligence process, the first CSI report having a first CPU occupancy, the first CPU type being an artificial intelligence CPU type; and
receiving the first CSI report.

32-40. (canceled)
